(19) United States
(12) Patent Application Publication
(10) Pub. No.: US 2026/0085981 A1
(43) Pub. Date: Mar. 26, 2026

(54) SENSOR ELEMENT AND METHOD OF MANUFACTURING A SENSOR ELEMENT

(71) Applicant: TDK Electronics AG, München (DE)

(72) Inventors: Anke Weidenfelder, Graz (AT); Jan Ihle, Raaba-Grambach (AT)

(21) Appl. No.: 19/110,319

(22) PCT Filed: Oct. 10, 2023
(86) PCT No.: PCT/EP2023/078002

§ 371 Date: Dec. 16, 2025

(30) Foreign Application Priority Data
Oct. 12, 2022 (DE) 10 2022 126 523.4

(51) Int. Cl. G01K 7/22; H01C 1/01; H01C 1/14; H01C 1/142; H01C 7/04; H01C 17/242

(52) U.S. Cl. CPC G01K 7/223; H01C 1/01; H01C 1/1413; H01C 1/142; H01C 7/041; H01C 17/242

(57) ABSTRACT

A sensor element for measuring a temperature has a carrier and at least one functional layer which has a material with a temperature-dependent electrical resistance. The functional layer is arranged on the carrier. The sensor element has at least two electrodes with electrode fingers and at least two contact pads for electrically contacting the sensor element. One contact pad is arranged directly on a partial area of one of the electrodes in each case. The sensor element is designed to be integrated into an electronic system as a discrete component. The sensor element has a narrow resistance tolerance. The functional layer and/or at least one of the at least two electrodes are structured to adjust the resistance value.

### FIELD OF THE INVENTION

The present invention relates to a sensor element, in particular a temperature sensor. The present invention further relates to a method for manufacturing at least one sensor element, preferably a temperature sensor.

### BACKGROUND OF THE INVENTION

In order to integrate passive components such as sensors, capacitors, protective components or heaters into electrical systems, the dimensions must be adapted for modern packaging designs, which are in the micrometer and even nanometer scale range. In order to achieve this degree of miniaturization, the components are deposited as thin films on carrier structures with electrical connections and described as discrete components. These novel components can be integrated into MEMS (Micro Electro Mechanical System) or SESUB (Semiconductor Embedded in Substrate) structures, among others.

The increasing demands on the accuracy of temperature measurement require tight tolerances in the resistance dispersion of such sensor elements. However, as structures become smaller, the manufacturing tolerances have an ever-increasing influence, as a result of which the resulting dispersion of the resistances exceeds the required tolerances. The resistance dispersion can only be reduced to a limited extent via the process control.

According to the state of the art, temperatures for monitoring and control in a wide variety of applications are mainly measured using ceramic thermistor elements (NTC), silicon temperature sensors (KTY), platinum temperature sensors (PRTD) or thermocouples (TC). Due to their low manufacturing costs, NTC thermistors are the most widely used. Another advantage over thermocouples and metallic resistance elements, such as Pt elements, is the distinctive negative resistance-temperature characteristic.

For use in power modules, SMD (“surface mounted device”) NTC temperature sensors are predominantly used, which are soldered on. Alternatively, NTC chips are also used in control modules for low power, which are mounted on the bottom side using Ag sinter paste, soldering or gluing and the top side is contacted via a bonding wire.

Metallic electrodes must be applied for electrical contacting of the NTC chips. According to the current state of the art, thick-film electrodes made primarily from silver or gold pastes are applied using a screen printing process with subsequent firing.

Very small elements are required for the integration of electronic components in MEMS or SESUB structures, for example, and it must also be possible to integrate them using suitable contacting methods. Conventional assembly technologies for SMD designs or NTC chips cannot be used for this.

The German patent application DE 10 2020 122 923 A1, the content of which is part of this application by reference, describes a sensor element for temperature measurement with a thin-film NTC thermistor.

Until now, thin-film NTC temperature sensors could not be manufactured with similarly tight tolerances as classic designs (SMD NTC and NTC chips).

### SUMMARY OF THE INVENTION

The object of the present invention is to describe a sensor element and a method of manufacturing a sensor element which solve the above problems.

This object is solved by a sensor element and a method of manufacturing a sensor element according to the independent claims.

According to one aspect, a sensor element is described. The sensor element 1 is suitable for measuring a temperature. The sensor element is a temperature sensor. Preferably, the sensor element is a thin-film NTC temperature sensor. An operating temperature of the sensor element is between −40° C. and 125° C., wherein the limits are included.

The sensor element has at least one carrier. Preferably, the sensor element has exactly one carrier. The carrier has a carrier material, preferably silicon, silicon carbide, GaN or glass (silicate or borosilicate glass). Alternatively, the carrier material can also comprise Si₃N₄, AlN or Al₂O₃.

The carrier has a top side and a bottom side. The top side is electrically insulating. Preferably, an insulating layer, for example Al₂O₃, AlN, SiO₂ or Si₃N₄ or combinations of layers of these materials, is formed on the top side of the carrier.

The insulating layer is formed directly on the top side of the carrier and can be made up of one or more layers.

The sensor element also has at least one functional layer. The functional layer is arranged on the carrier. In particular, the functional layer is arranged on the electrically insulating top side of the carrier.

The carrier mechanically stabilizes the functional layer. The functional layer can be formed directly on the carrier. Alternatively, other components of the sensor element, such as electrodes, can also be formed between the carrier and the functional layer.

A resistance of the sensor element is influenced by a structure, for example by a dimension or a width and/or by a specific shape of the functional layer. The width of the functional layer can vary.

A thickness of the functional layer is between 50 nm and 1 μm, preferably between 100 nm and 500 nm, particularly preferably between 250 nm and 400 nm. The functional layer has a material (functional material) that has a special electrical characteristic. The functional layer has a material with a temperature-dependent electrical resistance. For example, the specific resistance of the functional layer at an operating temperature of 25° C. is ρ=3 Ωm.

Preferably, the functional layer has an NTC ceramic. Preferably, the functional layer is a thin film with NTC characteristics. Preferably, the NTC ceramic is based on an oxidic material in the perovskite or spinel structure type. Alternatively, the functional layer can be based on a carbide or nitride material. Thin films of vanadium oxide or SiC are a further alternative.

The sensor element also has at least two electrodes. The electrodes are preferably designed as thin-film electrodes. The electrodes are spaced apart from each other on the carrier. Preferably, the electrodes do not extend to an edge area of the carrier. In particular, the electrodes are preferably formed in a central or inner area on the carrier. The respective electrode has a plurality of electrode fingers. The electrode fingers of the two electrodes are arranged alternately to one another. The electrodes therefore form an interdigital structure.

The resistance of the sensor element is influenced by a structure of the electrodes, for example a length and/or number of electrode fingers and/or a distance between the electrode fingers (gap width).

The sensor element also has at least two contact pads for electrically contacting the sensor element. Preferably, the sensor element has exactly two contact pads. The contact pads are directly electrically and mechanically connected to the electrodes. In each case, one contact pad is arranged directly on a partial area of one of the electrodes. The sensor element can also be mounted using thin-wire bonding via the contact pads.

The sensor element has a very compact design. In particular, the sensor element is designed to be embedded as a discrete component directly in an electrical or electronic system. For example, the sensor element has a maximum edge length of 1000 μm, preferably <800 μm, particularly preferably <500 μm. A thickness of the sensor element is <100 μm, preferably <80 μm, particularly preferably <50 μm. The dimensions of the sensor element are particularly preferably 300 μm×500 μm×50 μm. Preferably, the component is designed for direct integration into a MEMS structure and/or into a SESUB structure.

The sensor element further has a narrow resistance tolerance. This means that the sensor element has a very small deviation range from a nominal resistance (nominal value of the resistance).

The at least one functional layer and/or at least one of the at least two electrodes are structured to adjust the resistance value. The at least one functional layer and/or at least one of the at least two electrodes can be trimmed to adjust the resistance value. In particular, at least a partial area of the at least one functional layer and/or at least a partial area of at least one of the two electrodes is cut for resistance adjustment.

If the resistance of the component to be trimmed already corresponds to the target value, the structured/trimmable areas are not cut.

By achieving a narrow resistance tolerance, the sensor element has a very high accuracy in temperature measurement. Preferably, the sensor element has a resistance tolerance that is comparable to the narrow resistance tolerance of classic designs such as SMD NTCs or NTC chips.

An electrical characterization of the sensor element is similar to that of a standard NTC chip:
R(25° C.)=10 kΩ to 100 kΩ;
B(25/100)=2000 K to 4000 K,
   where the limits are included in each case. With a nominal resistance value of R(25° C.)<100 kΩ, the thickness of the functional layer in the optimized sensor element is 300 nm and the specific resistance of the functional layer is ρ=3 Ωm.

According to an embodiment, the functional layer only partially covers the carrier or the insulating layer on the top side of the carrier. Furthermore, the functional layer only partially covers the electrode fingers of the two electrodes.

A geometry/arrangement of the functional layer is initially selected so that the functional layer only covers the carrier/insulating layer in the area of the finger structure of the electrodes. Alternatively, the functional layer can also protrude beyond the finger structure of the electrodes. Preferably, the functional layer is only formed in a central area of the carrier. In particular, the functional layer does not protrude as far as an edge area of the carrier. Furthermore, the structure of the functional layer, for example a width of the functional layer, is selected so that a specific resistance (nominal value) of the sensor element can be set. This makes the sensor element particularly flexible to use and particularly precise.

According to one embodiment, the functional layer has a plurality of strips. In other words, the functional layer consists of discrete individual elements. The strips are arranged at a distance from one another. The strips are arranged parallel to each other.

The design of the sensor element is based on the principle of a parallel connection of individual resistors. The strips are designed perpendicular to the electrode fingers and are contacted via these. This results in several individual resistances that are connected in parallel between the electrode fingers.

A width of the strips can be the same for all strips of the functional layer. Alternatively, the width of the strips can also vary. For example, very narrow, medium and wide strips can be combined. This results in a greater variance in the resistance setting. In a parallel circuit, where the individual resistances are added as reciprocal values, this means that trimming larger resistances results in a small change in resistance across the entire sensor element. This makes it easy to fine-tune the nominal value of the resistance.

Trimming can be carried out in two ways. Either the functional layer or the electrode fingers can be cut. In particular, to adjust the resistance value of the sensor element, at least one strip of the functional layer and/or at least one electrode finger is cut through, preferably using a laser (laser trimming).

According to one embodiment, the functional layer or at least a part of the functional layer is stair-shaped, trapezoidal or triangular. The functional layer therefore does not have any discrete individual elements but is formed as a single piece. However, the functional layer only partially covers the electrodes, in particular the electrode fingers.

The specific structure of the functional layer and the fact that the electrode fingers are only partially covered result in different individual resistances, which are connected in parallel between the electrode fingers. This makes it easy to trim to a desired target resistance (nominal resistance). To set the resistance value, at least one electrode finger is cut, in particular by means of a laser (laser trimming). Another possible way for setting the resistance value is to cut through the functional layer along an electrode finger (i.e. between the electrode fingers) using a laser.

According to an embodiment, at least one electrode finger is structured. In particular, at least one of the electrode fingers has a different shape as compared to the other electrode fingers. Preferably, at least one of the electrode fingers is trapezoidal or triangular in shape. In comparison, the other electrode fingers have a square shape. This results in an even finer adjustment of the resistance due to a wider spread of the trimmable individual resistances between two adjacent electrode fingers.

According to an embodiment, the electrode fingers of at least one of the at least two electrodes are of different lengths. In other words, at least one, preferably exactly one, of the two electrodes has electrode fingers of different lengths.

This results in different individual resistances of the electrode fingers, which are connected in parallel between the electrode fingers and thus enable trimming to the desired target resistance. To adjust the resistance value, at least one of the electrode fingers of different lengths is cut through, in particular with the aid of a laser.

According to one embodiment, the distance between neighboring electrode fingers varies. This means that additional areas with varying distance are available for trimming, which results in an even finer gradation of the resistance setting.

To adjust the resistance value, at least one of the electrode fingers is cut through, in particular using a laser.

According to an embodiment, at least one of the electrode fingers has a comb-shaped area. The comb-shaped area has a plurality of teeth. The teeth point in the direction of the subsequent electrode finger. The comb-shaped area is preferably formed on one of the outer electrode fingers.

The teeth of the comb-shaped area can be of different lengths and/or widths. This results in a greater variance in the resistance setting. In particular, this results in different individual resistances, which makes trimming to the desired target resistance possible. At least one of the teeth is cut to adjust the resistance value of the sensor element.

According to one embodiment, the electrodes are formed directly on a top side of the functional layer. In other words, the functional layer is located between the electrodes and the carrier. This design allows the electrode to be trimmed after application and after having tested the sensor element. In addition, in this design the electrode does not have to withstand the conditions of the sintering process of the functional layer. Alternatively, the electrodes can also be arranged directly on a bottom side of the functional layer.

According to one embodiment, the sensor element has a protective layer. The protective layer can have oxides, nitrides, ceramics, glass or plastic as materials. The protective layer completely covers a top side of the sensor element with the exception of the contact pads. For this purpose, the protective layer has recesses at the location of the contact pads. The protective layer has a thickness of <10 μm, preferably <5 μm, ideally <1 μm. The protective layer improves the longterm stability of the sensor element.

According to a further aspect, a method for producing at least one sensor element, in particular a plurality of sensor elements, is described. It should be noted that the method preferably produces many sensor elements in parallel and finally separates them from one another. For the sake of simplicity, reference is made below essentially to one sensor element.

Preferably, the method produces the sensor element described above. All properties disclosed in relation to the sensor element or the method are also correspondingly disclosed in relation to the respective other aspect and vice versa, even if the respective property is not explicitly mentioned in the context of the respective aspect. The method comprises the following steps:

A) Provision of a carrier material to form a carrier. Preferably, the carrier material comprises Si, SiC, GaN or glass. Alternatively, the carrier material can have Si₃N₄, AlN or Al₂O₃. The carrier has a top side and a bottom side. An electrically insulating layer, preferably SiO₂, can also be formed on the top side of the carrier material.

B) Formation or deposition of at least two electrodes on the carrier. The deposition is carried out by a PVD (“physical vapor deposition”) process, a CVD (“chemical vapor deposition”) process or galvanically. Alternatively, deposition can also be carried out using an ALD (atomic layer deposition) process.

The electrodes are spaced apart from each other. In particular, the electrodes are spatially and electrically insulated from each other. The electrodes have electrode fingers. The electrodes interlock in the form of interdigital structures. Preferably, the electrodes are formed directly on the top side of the carrier or on the insulating layer. Alternatively, however, the electrodes can also be formed on the top side of the functional layer. The electrodes are formed in such a way that they are spaced apart from an edge area of the carrier.

The electrodes can be structured to adjust the resistance of the sensor element (see step E)).

C) Application, preferably sputtering, of a functional material to a partial area of the electrodes to form a functional layer. The functional material is preferably an NTC ceramic based on an oxidic material in the perovskite or spinel structure type. Alternatively, the functional material can also be based on a carbide or nitride material. Alternatively, the functional material may comprise or represent a thin film of vanadium oxide or SiC.

The functional layer is formed as a thin film. The functional layer only partially covers the carrier or the electrodes. In particular, the functional layer is formed in such a way that it is spaced from the edge area of the carrier and is formed on the area of the finger structures (interdigital structures) of the electrode. The functional layer can also protrude beyond the interdigital structure of the electrodes. The functional layer is deposited as a full-surface thin film and only structured in a further process step, e.g. by wet chemical etching or dry etching. After deposition, the NTC layer is not yet crystallized.

The functional layer can be structured to adjust the resistance of the sensor element (see step E)).

D) Temperature treatment of the functional layer. This serves to develop the NTC properties of the functional material and is carried out at temperatures of up to 1000° C.

The functional layer is then measured. The initial tolerance range of the resistance value is determined. At this stage of the process, this is, for example, the nominal value of the resistance ±5%.

E) Adjustment of the resistance value of the sensor element. This is done by trimming at least one of the electrodes and/or the functional layer using a laser. The resistance value is set to a predetermined nominal value (target value). Due to the precise adjustment of the resistance value, the finished sensor element has a very narrow resistance tolerance. The resistance tolerance of the nominal value of the finished sensor element is a maximum of ±5%, preferably a maximum of ±1%, particularly preferably a maximum of ±0.5%. The functional layer and/or at least one of the electrodes, for example at least one electrode finger, are structured for resistance adjustment. In other words, the functional layer and/or at least part of the electrodes have a structured area. An initial resistance of the functional layer is selected so that it is within a tolerance window at low resistance values.

The structured area is trimmed for the final adjustment of the resistance value. In particular, at least one of the electrode fingers and/or at least a partial area of the functional layer is cut through using the laser. In other words, material is removed from at least one electrode finger and/or at least part of the functional layer, which changes the resistance of the component in question and thus the overall resistance of the sensor element. The resistance of the sensor element is increased by trimming the structured areas to the nominal value.

However, if the resistance of the sensor element already corresponds to the nominal value, there is no additional adjustment of the resistance value.

According to an embodiment, the method has the following further steps:

F) Applying a protective layer to the top of the sensor element. The protective layer completely covers the top side except for two partial areas. The partial areas are arranged over a flat end section of the electrodes, to which the contact pads can be applied in the subsequent process step. The protective layer is for structuring either
(a) applied over the entire surface and the free partial areas created by a subsequent process such as wet chemical etching or dry etching or laser structuring, or
(b) directly patterned by using a mask during the deposition process.

G) Forming contact pads in the partial areas free of the protective layer for electrical contacting of the sensor element. In each case, a contact pad is formed directly on a flat end section of one of the electrodes. The contact pads can protrude beyond the structured protective layer.

The contact pads can have Cu, Au, Ni, Cr, Ag, Ti, Ta, W, Pd or Pt. If the sensor element is integrated into a SESUB structure, the contact pads preferably comprise Cu. Preferably, the contact pads then have a thickness of >5 μm. The contact pads are designed in such a way that they protrude beyond a surface of the finished sensor element.

As an alternative to the contact pads, bumps or thin electrodes can also be provided. All of these possible contact elements have at least one metal, for example Cu, Au or a solderable alloy.

H) Separating or singulating the sensor elements.

Separation takes place in two steps:
(1) Separation in x/y direction (length & width). This can be done by plasma etching or sawing, for example. The carrier is not sawn through, but only cut to a defined thickness.
(2) Separate in z-direction (height). Grinding is carried out from the rear. A grinding process removes material from the bottom side of the carrier up to a defined final component thickness.

I) If a thicker design of the sensor element is desired, it is not necessary to thin (grind) the carrier. In this case, separating is carried out by sawing or plasma etching alone.

J) Optional plasma etching of the ground-down bottom side of the carrier to reduce microcracks, for example.

According to one embodiment, the functional material is applied in a structured manner. In other words, the functional layer is structured to adjust the resistance value. The functional layer can have a plurality of strips. Alternatively, a partial area of the functional layer can be formed in a stepped, trapezoidal or triangular shape. This results in different individual resistances, which are connected in parallel between the electrode fingers and thus enable trimming to the desired target resistance.

According to an embodiment, the electrodes are structured for setting the resistance value. The electrode fingers of at least one of the two electrodes can have a different length. Alternatively or additionally, neighboring electrode fingers can have a different distance between them. Alternatively or additionally, the electrode fingers can have a different shape. For example, at least one of the electrode fingers may have a trapezoidal shape or at least one of the electrode fingers may have a comb-shaped area. The comb-shaped area can have a plurality of teeth, which preferably point in the direction of the subsequent electrode finger.

The structured design of the electrodes and/or the functional layer creates individual laser-trimmable areas, which makes it possible to adjust the resistance. The corresponding trimming increases the resistance to the nominal value. The individual trimmable/structured areas have a higher resistance compared to the non-structured areas. In a parallel circuit, where the individual resistances are added as reciprocal values, this means that trimming larger resistances results in a small change in resistance across the entire sensor element. This means that a sensor element with a particularly narrow resistance tolerance can be provided.

### BRIEF DESCRIPTION OF THE DRAWINGS

The drawings described below are not to be understood as true to scale. Rather, individual dimensions may be enlarged, reduced or even distorted for better representation.

Elements that are identical or have the same function are designated with the same reference signs.

FIG. 1 an exploded view of a sensor element according to the state of the art,

FIG. 2 a sectional view of the sensor element according to FIG. 1 (state of the art),

FIG. 3a a top view of a partial area of a sensor element according to a first embodiment,

FIG. 3b a top view of a partial area of a sensor element according to a further embodiment,

FIG. 4 a top view of a partial area of a sensor element according to a further embodiment,

FIG. 5 a top view of a partial area of a sensor element according to a further embodiment,

FIG. 6 a top view of a partial area of a sensor element according to a further embodiment,

FIG. 7 a top view of a partial area of a sensor element according to a further embodiment.

### DETAILED DESCRIPTION OF THE DRAWINGS

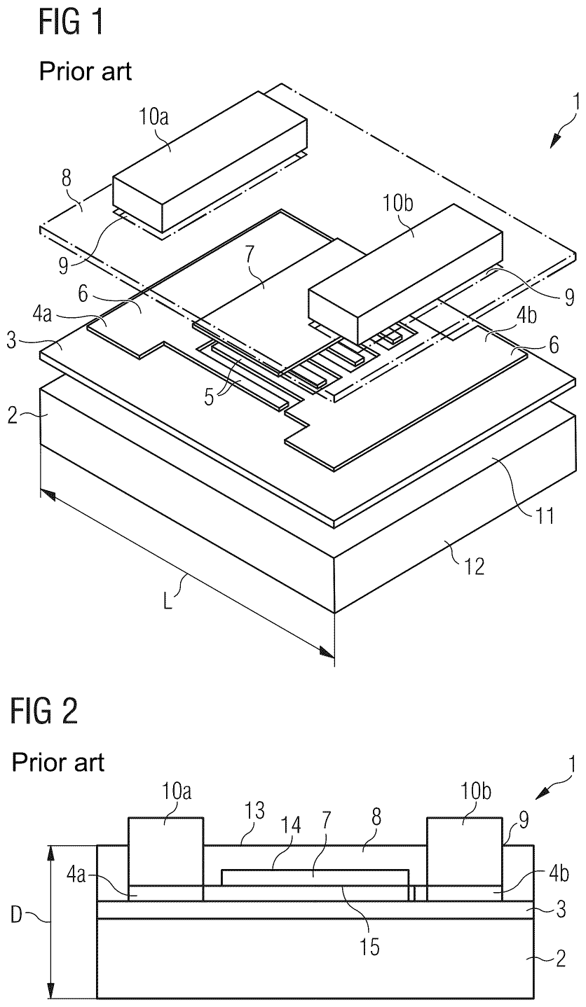

FIGS. 1 and 2 show a representation of a sensor element 1 according to the state of the art. The sensor element 1 serves to illustrate a basic structure of the sensor element 100 described below. Reference is made to the German patent application DE 10 2020 122 923 A1 with regard to the essential features of the sensor element 1 according to FIGS. 1 and 2.

The sensor element 1 is an NTC thin-film temperature sensor and has a carrier 2 with a top side 11 and a bottom side 12. The top side 11 of the carrier 2 has an insulating layer 3, for example comprising SiO₂. The sensor element 1 also has at least two electrodes 4a, 4b. The two electrodes 4a, 4b are spaced apart from each other on the insulating layer 3 of the carrier 2 and have thin metal films.

The electrodes 4a, 4b are designed as interdigital thin-film electrodes. In particular, the electrodes 4a, 4b each have a flat end section 6 and an area with electrode fingers 5. The area with the electrode fingers 5 is formed in a central area of the carrier 2. The flat end section 6 and the area with the electrode fingers 5 merge into one another. The two electrodes 4a, 4b interlock in the area of the electrode fingers 5 in the central area of the carrier 2 and form an interdigital structure there. The electrode fingers 5 of the electrodes 4a, 4b are arranged alternately.

The sensor element 1 also has a functional layer 7 with a top side 14 and a bottom side 15. The functional layer 7 is an NTC thin film. The functional layer 7 only partially covers the insulating layer 3 on the top side 11 of the carrier 2. Preferably, the functional layer 7 is at least partially applied to the electrodes 4a, 4b. As can be seen from FIGS. 1 and 2, the electrodes 4a, 4b are formed between the carrier 2 and the functional layer 7, in particular on a bottom side 15 of the functional layer 7. The functional layer 7 lies directly on the area with the electrode fingers 5.

The sensor element 1 also has at least two contact pads 10a, 10b for electrically contacting the sensor element 1.

The sensor element 1 can also have a protective layer 8. The protective layer 8 completely covers a top side of the sensor element 1 with the exception of the contact pads 10a, 10b. The protective layer 8 has recesses 9 from which the contact pads 10a, 10b protrude for electrical contacting of the sensor element 1.

Due to the compact design of the individual components of the sensor element 1, the sensor element 1 is ideally suited for integration into MEMS or SESUB structures.

The design of the basic structure shown in FIGS. 1 and 2 is based on the principle of a parallel connection of individual resistances. However, in the design of the sensor element 1 as shown in FIGS. 1 and 2, the resistance cannot be adapted to the specific component. The dispersion of the resistance can therefore not be adjusted within the required tolerances.

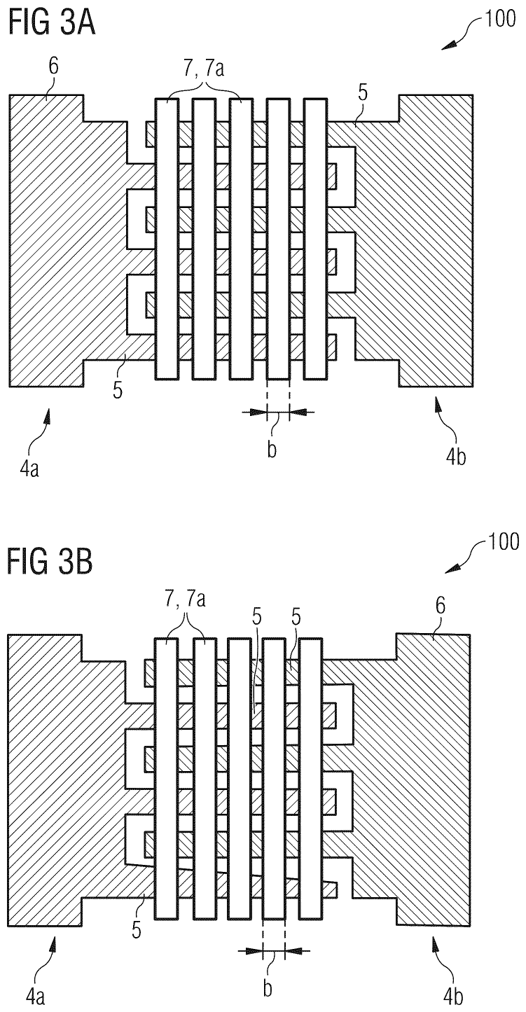

FIGS. 3a, 3b and 4 to 7 each show a partial area of a sensor element 100. The sensor element 100 has essentially the same components as the sensor element 1 according to FIGS. 1 and 2. The basic structure of the sensor element 100 corresponds to the structure of the sensor element 1 of FIGS. 1 and 2, as already mentioned above. Reference is therefore made to the above description or to document DE 10 2020 122 923 A1 with regard to the details of the components and the mode of operation of the sensor element 100.

The sensor element 100 according to the invention has an operating temperature between −40° C. and 125° C., the limits being included. A dimension of the sensor element 100 is preferably 300 μm×500 μm×50 μm. The sensor element 100 has a resistance value R, for which the following applies: 10 kΩ R(25° C.)≤100 kΩ.

In contrast to sensor element 1, the resistance of the sensor element 100 shown in FIGS. 3 to 7 can be adjusted to suit the specific component. This can be realized by different variants of the layer structure of the sensor element 100, which are described in detail below. In particular, the structure of the functional layer 7 and/or the electrodes 4a, 4b is adapted/modified compared to sensor element 1.

A width and/or shape of the functional layer 7 and/or a length of the electrode fingers 5 and/or a distance (gap width) between the electrode fingers 5 and/or a number of the electrode fingers 5 or the distances (gaps) between the electrode fingers 5 influence the resistance value of the sensor element 100.

The relationship between the resistance and the interdigital structure of the electrodes 4a, 4b is shown in particular in Table 1 below:

TABLE 1
Relationship between the structure of the
electrodes and the resistance value.

| | Variant A | Variant B |
|---|---|---|
| Length of the electrode fingers 5 [μm] | 170 | 190 |
| Width between electrode fingers 5/ | 10 | 5 |
| gap width [μm] | | |
| Number of gaps | 10 | 20 |
| R(25° C.)/kΩ | 50 | 12 |

The table shows that the resistance of the sensor element 100 at an operating temperature of 25° C. decreases with increasing number of electrode fingers 5/number of gaps between the electrode fingers 5 as well as increasing length of the electrode fingers 5 and decreasing distance (gap width) between the electrode fingers 5.

Thus, in variant B with a greater length and number of electrode fingers 5 and a smaller distance between the electrode fingers 5, a resistance of R(25° C.)=12 kΩ can be expected. In variant A with a smaller length, number and greater distance, a resistance of R(25° C.)=50 kΩ is present.

In this way, the resistance value can be specifically influenced by targeted structuring of the interdigital structure of the electrodes 4a, 4b or the functional layer 7. This is described again in more detail in connection with FIGS. 3A to 7.

The structured design of the electrodes 4a, 4b and/or the functional layer 7 creates individual laser-trimmable areas, which makes it possible to adjust the resistance. An initial resistance of the functional layer 7 is selected so that it is within the tolerance window at low resistance values. The corresponding trimming increases the resistance to the nominal value.

The individual trimmable/structured areas have a greater resistance compared to the non-structured areas of the basic structure (sensor element 1). In a parallel circuit, in which the individual resistances are added as reciprocal values, this means that trimming larger resistances causes a small change in resistance on the entire sensor element 100. Trimming is carried out with a suitable laser.

In the embodiment shown in FIG. 3a, the functional layer 7 is structured. In particular, in contrast to the basic structure, the functional layer 7 is structured in such a way that individual strips are formed 7a, which are perpendicular to the electrode fingers 5 and are contacted via these. This results in several individual resistances that are connected in parallel between the electrode fingers 5.

A width b of the strips 7a can be the same for all strips 7a or can vary, so that, for example, (very) narrow, medium and wide strips 7a are present in combination and thus a greater variance in the resistance setting is given. The strips 7a can only partially cover the electrode fingers 5, as shown in FIG. 3a. Alternatively, the strips 7a can also be formed in at least part of the flat end section 6 of the electrodes 4a, 4b (not explicitly shown).

Trimming is carried out with the help of a laser. It can be carried out in two ways. Depending on the type of laser used, either the functional layer 7 (in particular individual strips 7a of the functional layer 7) or one or more electrode fingers 5 can be cut through.

In this embodiment, the electrode fingers 5 can be cut both in the transition area of the electrode fingers 5 to the flat end sections 6 of the electrode 4a, 4b and in an area between the individual strips 7a of the functional layer 7.

In the embodiment shown in FIG. 3b, an electrode finger 5 of one of the electrodes 4a, 4b is also structured. In particular, in this embodiment, an outer electrode finger 5 of the electrode 4a is trapezoidal in shape. Furthermore, several electrode fingers 5 can also be structured or, alternatively or additionally, one of the inner electrode fingers 5 can be structured (not explicitly shown).

The specific design of at least one electrode finger 5 results in an even finer adjustment of the resistance due to a wider spread of the trimmable individual resistances between neighboring electrode fingers 5.

Here too, trimming (depending on the laser used) can be carried out by cutting through individual strips 7a of the functional layer 7 or the electrode fingers 5. Cutting through the electrode fingers 5 is possible both in the transition area of the electrode fingers 5 to the flat end sections 6 of the electrode 4a, 4b and in an area between the individual strips 7a of the functional layer 7.

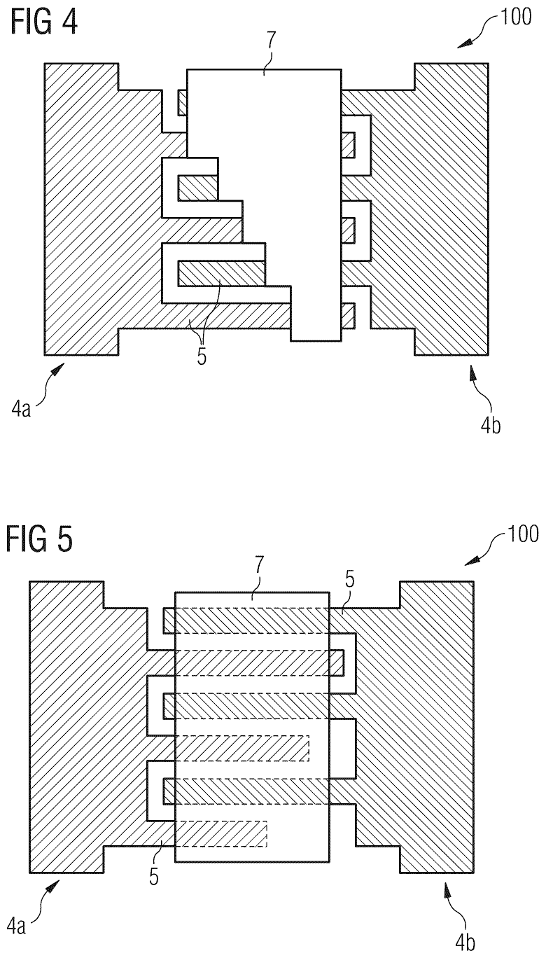

In the embodiment shown in FIG. 4, the functional layer 7 is structured. In particular, the functional layer 7 has a stepped structure. Alternatively, the functional layer can also be trapezoidal or triangular in shape (not explicitly shown). Unlike in the embodiments shown in FIGS. 3a and 3b, the functional layer does not have a plurality of discrete individual elements but is formed as a single piece.

Despite the flat design, the functional layer 7 only covers a partial area, in particular partial areas of different sizes, of the individual electrode fingers 5. The functional layer 7 can also extend into the flat end section 6 of the electrodes 4a, 4b (not explicitly shown), i.e. the overall width of the functional layer 7 can vary.

This results in different individual resistances, which are connected in parallel between the electrode fingers 5 and thus enable trimming to the desired target resistance. Trimming is carried out by cutting at least one electrode finger 5 using a laser.

In the embodiment shown in FIG. 5, one of the electrodes 4a, 4b is structured. In particular, the electrode 4a has electrode fingers 5 of different lengths, whereby the structuring can alternatively or additionally also be formed on the electrode 4b.

The electrode finger shown at the very bottom in FIG. 5 (lower outer electrode finger 5) is the shortest electrode finger 5. The electrode finger shown at the very top in FIG. 5 (upper outer electrode finger 5) is the longest electrode finger 5. Of course, another electrode finger 5, for example a middle electrode finger 5, can also be shorter or longer than the other electrode fingers 5. In other words, a length of the electrode fingers 5 and an arrangement of the electrode fingers 5 of different lengths can be freely selected—depending on the desired resistance value.

In this embodiment, the functional layer 7 is flat or rectangular, analogous to the basic structure described in connection with FIGS. 1 and 2. However, the functional layer 7 can also extend into the flat end section 6 of the electrodes 4a, 4b (not explicitly shown). In other words, the width of the functional layer 7 or a width of the area of the electrodes 4a, 4b covered by the functional layer 7 can vary. By varying the width, the resistance value can be influenced, as already mentioned above.

The different lengths of the electrode fingers 5 result in different individual resistances, which are connected in parallel between the electrode fingers 5 and thus enable trimming to the desired target resistance.

Here too, trimming is carried out by cutting at least one electrode finger 5 using a laser. In contrast to the designs with structured functional layer 7, the electrode fingers 5 can only be cut in the transition area of the electrode fingers 5 to the flat end sections 6 of the electrode 4a, 4b (area of the electrode fingers 5 not covered by the functional layer 7).

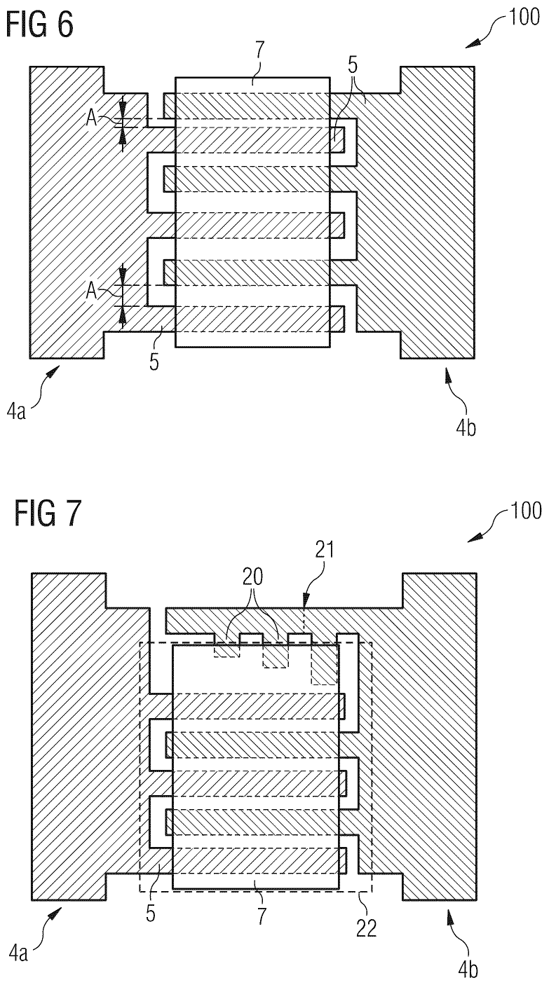

In the embodiment shown in FIG. 6, the electrode fingers 5 are at different distances from each other. In particular, a distance A between adjacent electrode fingers 5 can be varied by the specific configuration of the electrodes 4a, 4b. As described above, the resistance value of the sensor element 100 is influenced by changing the distance A between the electrode fingers 5 (see Table 1).

Thus, the electrode fingers 5, which are shown in FIG. 6 below, have a greater distance A between them than the other electrode fingers 5. This design is not limited to this particular embodiment, but the distance A between adjacent electrode fingers 5 can be increased or decreased as desired, depending on which resistance values are to be achieved. The distance A of only one adjacent pair of electrode fingers or of several pairs of electrode fingers can be varied.

This special design allows additional areas with varying distances to be created for trimming. This results in the option of an even finer gradation of the resistance setting.

In the embodiment according to FIG. 7, at least one electrode finger 5 is structured. In particular, one electrode finger 5 (in this embodiment, an outer electrode finger 5 of the electrode 4b) has a comb-shaped area. However, a corresponding comb-shaped area can also be provided on further or other outer electrode fingers 5 (not explicitly shown).

The comb-shaped area has a plurality of teeth 20. These point in the direction of the following electrode finger 5. The teeth 20 are of different lengths. Alternatively or additionally, the teeth 20 can also be of different widths.

The functional layer 7 does not extend completely over the structured electrode finger 5, as can be seen in FIG. 7. Rather, the functional layer 7 only partially covers the structured electrode finger 5. In this embodiment, the functional layer can also be even wider and, in particular, extend as far as the flat end sections 6 and even partially over the flat end sections 6 of the electrodes 4a, 4b (see functional layer 22 indicated by a dashed line). As already mentioned above, the resistance value is influenced by varying the width of the functional layer 7.

The comb-shaped structure of the electrode finger 5 provides a greater variance in the resistance setting. This results in different individual resistances, which enable trimming to the desired target resistance. Trimming is carried out by cutting the structured electrode finger 5 with the aid of a laser (see exemplary separation area 21).

In the following, a method for manufacturing the sensor element 100 is described. Preferably, the method is used to manufacture a plurality of sensor elements 100 according to one of the embodiments described above (see FIGS. 3a, 3b and 4 to 7). All features described in connection with the sensor element 100 therefore also apply to the method and vice versa.

In a first step A), a carrier material is provided to form the carrier 2 described above. Preferably, the carrier material comprises Si, SiC, GaN or glass. Alternatively, the carrier material may comprise Si₃N₄, AlN or Al₂O₃. The carrier 2 has a top side 11 and a bottom side 12. Preferably, the carrier 2 has a maximum edge length L of less than 500 μm.

An electrically insulating layer 3 is then formed on the top side 11 of the carrier 2. For example, the insulating layer 3 has SiO₂. Ideally, an insulating layer 3 with a thickness of up to 1.5 μm is produced on the top side 11 of the carrier 2.

In a further step B), at least two electrodes 4a, 4b are formed/deposited on the carrier 2. The deposition is carried out by a PVD or CVD process or electroplating.

The electrodes 4a, 4b can be single-layered or multi-layered and have, for example, Cu, Au, Ni, Cr, Ag, Ti, Ta, W, Pd or Pt. The electrodes 4a, 4b are designed as thin-film electrodes. The electrodes 4a, 4b each have a flat end section 6 and a plurality of electrode fingers 5.

The electrodes 4a, 4b are structured in a subsequent process, which can be wet chemical etching or dry etching or laser structuring, for example. The electrode fingers 5 of at least one of the two electrodes 4a, 4b can have a different length (FIG. 5). Alternatively or additionally, neighboring electrode fingers 5 can have a different distance A from each other (FIG. 6). Alternatively or additionally, the electrode fingers 5 can have a different shape (FIGS. 3b, 7). For example, at least one of the electrode fingers 5 may have a trapezoidal or stepped shape or at least one of the electrode fingers 5 may have a comb-shaped area with teeth 20. The resistance value of the sensor element 100 is influenced by the structuring. The structuring creates a laser-trimmable area for adjusting the resistance value of the sensor element 100. In addition or alternatively, the functional layer 7 can also have a structuring (FIGS. 3a, 3b, 4). The resistance of the sensor element 100 is also influenced by the structuring of the functional layer 7.

In a further step C), a functional material is applied to form a functional layer 7. This is done, for example, by sputtering or a spin coating process. The functional material is initially applied over the entire surface and structured in a further process (for example by wet chemical etching or dry etching or laser structuring). Preferably, the functional layer 7 has a thickness of between 250 nm and 400 nm.

Alternatively, step C) can also be carried out before step B), so that the functional material 7 is sputtered directly onto the insulating layer 3 of the carrier 2 and the electrodes 4a, 4b are then applied to the functional layer 7.

The functional material has an NTC ceramic based on an oxidic material in the perovskite or spinel structure type. Alternatively, the functional material can also be based on a carbide or nitride material. In a further alternative, the functional material comprises or consists of thin films of vanadium oxide or SiC.

The functional layer 7 only partially covers the top side of the carrier 2 or the electrodes 4a, 4b. The functional layer 7 can be structured to adjust the resistance value of the sensor element 100. For example, the functional layer 7 can be strip-shaped (FIGS. 3a, 3b). Alternatively, the functional layer 7 can be formed in a stepped, trapezoidal or triangular shape (FIG. 4). Alternatively or additionally, the width of the functional layer can be varied. This results in different individual resistances, which are connected in parallel between the electrode fingers 5 and thus enable trimming to the desired target resistance. The initial resistance of the functional layer 7 is selected so that it is within the tolerance window at low resistance values.

In a further step D), the functional layer 7 is subjected to a heat treatment to form the structure or properties.

The functional layer 7 is then measured. The initial value of the resistance value is determined so that the resistance can be set to the nominal value in the next step.

In the next step E), the resistance value is adjusted by trimming at least one of the electrodes 4a, 4b and/or the functional layer 7 using a laser. Trimming is preferably carried out in situ.

The resistance value is set to a predetermined nominal value (nominal value). Due to the precise setting of the resistance value, the finished sensor element 100 has a very narrow resistance tolerance. To set the resistance value, at least one of the electrode fingers 5 and/or at least a partial area of the functional layer 7 is cut through using the laser. In particular, the structured areas described above are cut through.

In the next step F), a protective layer 8 is formed. The protective layer 8 can comprise oxides, nitrides, ceramics, glasses or polymers and is produced using a PVD or CVD process and structured using wet chemical etching or dry etching. The protective layer 8 has a thickness of <10 μm, preferably <5 μm, particularly preferably <1 μm. Ideally, the protective layer 8 has a thickness <1.5 μm and completely covers the top side of the sensor element 100 with the exception of the contact pads 10a, 10b.

Subsequently, in step G), contact pads 10a, 10b are formed on at least a partial area of the electrodes 4a, 4b. In each case, a contact pad 10a, 10b is formed directly on the flat end section 6 of an electrode 4a, 4b. In one embodiment, the contact pads 10a, 10b comprise metals such as Cu, Al or Au and have a thickness of >5 μm. In particular, in the finished sensor element 100 the contact pads 10a, 10b protrude beyond the surface 13 of the sensor element 100. Alternatively, bumps can be formed instead of the contact pads.

In a further step H), the sensor elements 100 are separated, for example by plasma etching or sawing. The carrier 2 is not sawn through, but only cut to a defined thickness.

Subsequent optional grinding from the back (a grinding process) removes material from the back of the carrier 2 to a defined final component thickness in a final step I). This step results in the actual separation of the sensor elements 100. If a thicker design of the sensor element 100 is desired, step I) can also be omitted. In this case, the sensor elements 100 are separated by sawing or plasma etching alone. The separated sensor elements 100 can be mounted on the top side via thin-wire bonding on the contact pads.

The description of the objects specified here is not limited to the individual special embodiments. Rather, the features of the individual embodiments can be combined with each other as desired, insofar as this makes technical sense.

### LIST OF REFERENCE SIGNS

1, 100 Sensor element
2 Carrier
3 Insulating layer
4a,b Electrode
5 Electrode finger
6 End section
7 Functional layer
7a Strip
8 Protective layer
9 Recess
10a,b Contact pad
11 Top side of the carrier
12 Bottom side of the carrier
13 Surface of the sensor element
14 Top side of the functional layer
Bottom side of the functional layer
Tooth
21 Separation area
22 Functional layer
D Thickness of the sensor element
L Edge length of the carrier
A Distance between adjacent electrode fingers
b Width of the strips

1-38. (canceled)

39. A sensor element for measuring a temperature, comprising
at least one carrier with a top side and a bottom side;
an electrically insulating layer formed on the top side of the carrier;
at least one functional layer comprising a material with a temperature-dependent electrical resistance, the at least one functional layer being arranged on the electrically insulating layer;
at least first and second electrodes formed on the carrier at a distance from one another, each of the first and second electrodes having a plurality of electrode fingers, the electrode fingers of the first and second electrodes being arranged alternately with respect to one another;
at least first and second contact pads for electrically contacting the sensor element, the first contact pad being arranged directly on a partial region of the first electrode, the second contact pad being arranged directly on a partial region of the second electrode; and
wherein the sensor element is designed to be integrated directly into an electrical system as a discrete component, wherein the sensor element has a narrow resistance tolerance, and wherein the at least one functional layer and/or at least one of the first and second electrodes are structured for adjusting a resistance value of the sensor element.

40. The sensor element according to claim 39, wherein the functional layer only partially covers the plurality of electrode fingers.

41. The sensor element according to claim 39, wherein a width of the functional layer varies.

42. The sensor element according to claim 39, wherein the functional layer comprises a plurality of strips which are arranged spaced apart and parallel to one another on the top side of the carrier.

43. The sensor element according to claim 42, wherein the plurality of strips are formed perpendicular to the plurality of electrode fingers and are contacted via these.

44. The sensor element according to claim 42, wherein a width of each of the plurality of strips is the same for all of the plurality of strips.

45. The sensor element according to claim 42, wherein at least a partial region of at least one strip and/or at least a partial region of at least one of the electrode fingers is cut for adjusting the resistance value of the sensor element.

46. The sensor element according to claim 39, wherein the functional layer has a stepped, trapezoidal, or triangular shape.

47. The sensor element according to claim 46, wherein at least one of the plurality of electrode fingers is cut to adjust the resistance value of the sensor element.

48. The sensor element according to claim 39, wherein at least one of the plurality of electrode fingers has a different shape as compared to other ones of the plurality of electrode fingers, and wherein the at least one electrode finger is trapezoidal or triangular in shape.

49. The sensor element according to claim 39, wherein the plurality of electrode fingers of the first electrode include electrode fingers of different lengths compared to the plurality of electrode fingers of the second electrode.

50. The sensor element according to claim 49, wherein at least one of the electrode fingers of different lengths is cut to adjust the resistance value of the sensor element.

51. The sensor element according to claim 39, wherein a distance between adjacent ones of the plurality of electrode fingers varies.

52. The sensor element according to claim 39, wherein at least one of the plurality of electrode fingers has a comb-shaped area, the comb-shaped area having a plurality of teeth that point in the direction of an adjacent one of the plurality of electrode fingers.

53. The sensor element according to claim 52, wherein the comb-shaped area is formed on an outermost one of the plurality of electrode fingers.

54. The sensor element according to claim 52, wherein the plurality of teeth include at least one tooth of a different length and/or a different width relative to the other of the plurality of teeth.

55. The sensor element according to claim 52, wherein at least a partial region of the electrode finger with the comb-shaped area is cut to adjust the resistance value of the sensor element.

56. The sensor element according to claim 39, wherein at least one of the first and second electrodes is designed as a thin-film electrode.

57. The sensor element according to claim 39, where the functional layer is a thin film with negative temperature coefficient (NTC) characteristics.

58. The sensor element according to claim 39, wherein the sensor element is designed for direct integration into a MEMS structure and/or into a SESUB structure.

59. The sensor element according to claim 39, wherein the carrier is comprised of silicon, silicon carbide, glass, or wherein the carrier includes a carrier material comprising Si₃N₄, AlN, GaN or Al₂O₃.

60. The sensor element according to claim 39, wherein the functional layer comprises an NTC ceramic based on an oxidic material in the perovskite or spinel structure type, or wherein the functional layer comprises an NTC ceramic based on a carbidic or a nitridic material.

61. The sensor element according to claim 39, wherein the plurality of electrodes are single-layered or multi-layered and comprise at least one material of or a material combination of Cu, Au, Ni, Cr, Ag, Ti, Ta, W, Pd and/or Pt.

62. The sensor element according to claim 39, wherein the contact pads are single-layered or multi-layered and comprise at least one material of or a material combination of Cu, Au, Ni, Cr, Ag, Ti, Ta, W, Pd and/or Pt.

63. The sensor element according to claim 39, wherein the insulating layer is formed as a single layer or multi-layer and comprises Al₂O₃, AlN, SiO₂ or Si₃N₄, or combinations of layers of Al₂O₃, AlN, SiO₂ or Si₃N₄.

64. The sensor element according to claim 39, further comprising a protective layer, wherein the protective layer completely covers a top side of the sensor element with the exception of the plurality of contact pads.

65. The sensor element according to claim 64, wherein the protective layer is formed as a single layer or multi-layer and comprises Al₂O₃, AlN, SiO₂ or Si₃N₄, or combinations of layers of Al₂O₃, AlN, SiO₂ or Si₃N₄.

66. The sensor element according to claim 64, wherein the protective layer comprises oxides, nitrides, ceramics, glasses or plastics as the material.

67. A method of manufacturing a sensor element comprising the following acts:
A) providing a carrier material with an insulating layer for forming a carrier;
B) forming at least two electrodes on the carrier, the respective electrode having a plurality of electrode fingers, the electrode fingers of the two electrodes being arranged alternately with respect to one another;
C) applying a functional material to a partial area of the electrodes to form a functional layer;
D) affecting the functional layer with temperature treatment; and
E) adjusting a resistance value of the sensor element by trimming at least a partial area of the electrodes and/or of the functional layer by means of a laser.

68. The method according to claim 67, wherein the functional layer and/or at least one of the electrodes are formed in a structured manner, and wherein an initial resistance of the functional layer is selected such that it is within a tolerance window at low resistance values, whereby a resistance of the sensor element is increased by trimming the structured areas to a nominal value.

69. The method according to claim 67, wherein in step E) at least a partial area of the electrode fingers and/or at least a partial area of the functional layer are cut to adjust the resistance value.

70. The method according to claim 67, wherein the functional layer is measured before step E).

71. The method according to claim 67, further comprising the following acts:
F) Application of a protective layer to a top side of the sensor element, wherein the protective layer completely covers the top side except for two partial areas;
G) Forming contact pads in the partial areas free of the protective layer for electrical contacting of the sensor element;
H) Separating the sensor elements.

72. The method according to claim 67, further comprising the following acts:
I) optional grinding of the sensor elements from a bottom side, whereby material is removed by a grinding process from the rear side of the carrier up to a defined final component thickness, whereby the sensor elements are separated;
J) optional plasma etching of the ground bottom side of the carrier to reduce microcracks.

73. The method according to claim 67, wherein the functional layer has a plurality of strips or wherein the functional layer is formed in a stepped, trapezoidal or triangular shape.

74. The method according to claim 67, wherein a width of the functional layer varies.

75. The method according to claim 67, wherein the electrode fingers of at least one of the two electrodes have a different length, and/or wherein adjacent electrode fingers have a different distance from one another, and/or wherein the electrode fingers have a different shape.

76. The method according to claim 67, wherein at least one of the electrode fingers is trapezoidal or triangular in shape or wherein at least one of the electrode fingers has a comb-shaped area, wherein the comb-shaped area has a plurality of teeth which point in the direction of the subsequent electrode finger.
